(19) United States
(12) Patent Application Publication
(10) Pub. No.: US 2018/0291869 A1
(43) Pub. Date: Oct. 11, 2018

(54) Vertical Axis Wind Turbine

(71) Applicant: Sauer Energy, Inc., Oxnard, CA (US)

(72) Inventors: Dieter R. Sauer, JR., Oxnard, CA (US); James Michael Hubbard, Newbury Park, CA (US)

(73) Assignee: Sauer Energy, Inc., Oxnard, CA (US)

(21) Appl. No.: 15/485,163

(22) Filed: Apr. 11, 2017

(51) Int. Cl. F03D 3/00; F03D 80/70; F03D 3/06; F03D 9/25; F03D 7/06

(52) U.S. Cl. CPC F03D 3/005; F03D 80/70; F03D 7/06; F03D 9/25; F03D 3/064

(57) ABSTRACT

A vertical axis wind turbine has a blade assembly including set of planar, vertically extending blades and a frame that stabilizes and supports the blades as they rotate. A generator is located at the blade assembly's center of mass. A first bearing supports the blade assembly for rotation about a blade support shaft; a second bearing maintains the generator shaft in vertical alignment with the blade support shaft; and a third bearing supports the weight of the generator rotor and housing as they rotate about the generator shaft.

### TECHNICAL FIELD

The present disclosure relates in general to turbines for converting wind energy into electrical energy and more particularly to a vertical axis wind turbine.

### BACKGROUND

Wind turbines generally fall into two categories: horizontal axis and vertical axis. A horizontal axis wind turbine is mounted on a vertical tower, and includes a blade assembly that rotates about a horizontal axis to turn the rotor of an electrical generator. Because the blade assembly must always be pointed into the wind, a wind vane or servo motor is provided for rotating the turbine about the longitudinal axis of the tower. A vertical axis wind turbine has a vertical rotor shaft and does not need to be pointed into the wind.

Vertical axis wind turbines are less commonly used than horizontal axis wind turbines. Nonetheless, they have several advantages that make them preferable for use in certain applications. For instance, because they are omni-directional, they are appropriate for use in locations where winds are variable, gusty, or turbulent. In addition, their lack of wind-sensing and tracking mechanisms makes them somewhat simpler to operate and maintain. They are also more compact than horizontal axis wind turbines, making it possible to group them more closely together in wind farms, increasing the generated power per unit land area.

Since vertical axis wind turbines are often used in locations with variable winds, the vertically oriented blades are subjected to variable forces. These forces are transmitted to the generator and bearings of the turbines, which can lead to structural failure if the frame of the turbine does not provide adequate support and stabilization. These and other problems are addressed by this disclosure as summarized below.

### SUMMARY

A wind turbine includes generator and a blade assembly. The blade assembly is configured to rotate about a vertical axis, and the generator is located approximately at the blade assembly's center of mass. In one aspect of the disclosure, the turbine includes a vertical blade support shaft, a vertical generator shaft, and three bearings including a first bearing supporting the blade assembly for rotation about the blade support shaft, a second bearing limiting lateral movement of the generator shaft, and a third bearing supporting the weight of the generator.

The blade assembly may include a plurality of vertically extending blades, wherein each blade is symmetrical about a common horizontal plane of symmetry, and the generator is located in the horizontal plane of symmetry. The blade assembly may also have a frame including an upper support subassembly including a plurality of top struts extending upwardly between the generator and the blades, and a plurality of bottom struts extending downwardly between the generator and the blades.

The upper support subassembly may further include a central support pole extending upwardly from the upper portion of the housing, and a plurality of upper spokes extending horizontally and radially between the central support pole and the top struts. The lower support assembly may further include a plurality of lower spokes extending horizontally and radially between the blade support shaft and the bottom struts.

The generator may include a generator housing including a top support plate, a bottom support plate, and an isolator assembly configured to space the top and bottom support plates from the generator rotor, and to reduce transmission of vibrations from the blade assembly to the generator rotor. The isolator assembly may include a set of upper isolators separating the top support plate from a top surface of the generator rotor, and a set of lower isolators separating the bottom support plate from a bottom surface of the generator rotor. Each isolator may include a cylindrical shock-absorbing member and a fastener. The shock-absorbing member may have a bore for receiving the fastener at one end, and the other end may be formed as a projection that extends into a recess formed in a surface of the generator rotor.

The blade assembly may also include a disc coupled to a bottom support plate of the generator, and a piston and caliper assembly coupled to a circular flange extending radially outwardly from the blade support shaft, wherein the piston and caliper assembly cooperates with the disk to slow or stop rotation of the blade assembly when necessary.

In another aspect of the disclosure, the wind turbine includes a vertically extending blade support shaft, a plurality of vertically extending blades, a generator, and three bearings, wherein the first bearing supports the blades for rotation about the blade support shaft, the second bearing limits lateral movement of the generator shaft, and the third bearing supports the weight of the generator housing. The blades may be supported by a frame including an upper support subassembly including a plurality of top struts extending diagonally upwardly between the generator and the blades, and a plurality of bottom struts extending diagonally downwardly between the generator and the blades.

The upper support subassembly may further include a central support pole extending upwardly from generator housing, a plurality of radially extending upper spokes, each upper spoke having a first end secured to a top end of the central support pole and a second end secured to a top strut, and a plurality of upper brace bars, each upper brace bar extending transversely between adjacent upper spokes. The lower support subassembly may further include a plurality of lower brace bars, each lower brace bar extending transversely between adjacent bottom struts, and a plurality of radially extending lower spokes, each lower spoke having a first end secured to the first bearing and a second end secured to a lower brace bar.

The wind turbine may also include a disc coupled to and suspended beneath the generator housing, and a piston and caliper assembly cooperating with the disc to function as a brake stopping or slowing rotation of the blades. The disc may be integrally coupled to the generator housing by at least one bar extending downwardly from the generator housing, and a mechanism for actuating the piston and caliper assembly may be secured to a platform extending radially outwardly from the blade support shaft. The second bearing may be located between the platform and the disc, and the third bearing may encircle the generator.

In still another aspect of the disclosure, the wind turbine includes a plurality of vertically extending blades, and a generator having a generator housing and a generator shaft. Each blade is symmetrical about a common horizontal plane of symmetry, and the generator is located in the horizontal plane of symmetry of the blade. The blades and the generator housing are supported for rotation about a common vertical axis.

The blades may be secured to the generator housing by a frame having an upper support subassembly including a plurality of top struts extending diagonally upwardly between the generator housing and the blades, and a lower support subassembly including a plurality of bottom struts extending diagonally downwardly between the generator housing and the blades. A first bearing secured to the lower support subassembly may support the frame for rotation about a vertically extending blade support shaft. A second bearing may maintain the generator shaft in axial alignment with the blade support shaft, and a third bearing may support the weight of the generator housing.

The upper support subassembly may further include a central support pole extending upwardly from generator housing, a plurality of radially extending upper spokes, each upper spoke having a first end secured to a top end of the central support pole and a second end secured to a top strut, and a plurality of upper brace bars, each upper brace bar extending transversely between adjacent upper spokes. The lower support subassembly may further include a plurality of lower brace bars, each lower brace bar extending transversely between adjacent bottom struts, and a plurality of radially extending lower spokes, each lower spoke having a first end secured to the first bearing and a second end secured to a lower brace bar. The central support pole may be coaxial with the generator shaft and the blade support shaft.

### BRIEF DESCRIPTION OF THE DRAWINGS

FIG. 1 is a perspective view showing a wind turbine according to the present invention.

FIG. 2 is a top view of the wind turbine of FIG. 1.

FIG. 3 is a front elevation of the wind turbine of FIG. 1.

FIG. 4 is a fragmentary perspective view showing the hub assembly and lower support subassembly of the frame of the wind turbine of FIG. 1.

FIG. 5 is a perspective view showing the hub assembly of the wind turbine of FIG. 1.

FIG. 6 is an enlarged detailed view of a braking assembly in the hub assembly of FIG. 5.

FIG. 7 is a longitudinal sectional view of the hub assembly shown in FIG. 5, with the braking assembly removed for purposes of clarity.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

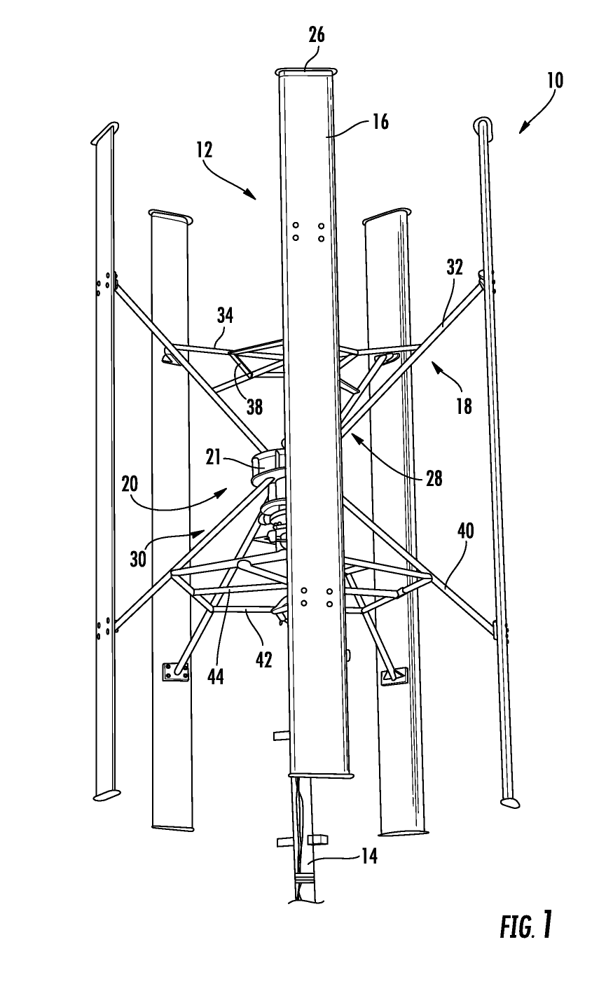

A vertical axis wind turbine, indicated in its entirety in FIG. 1 by the numeral 10, includes a blade assembly 12 mounted for rotation about a vertical tower or pole 14. The blade assembly 12 includes five substantially planar, vertically extending blades 16 and a generally hourglass-shaped frame 18 that stabilizes and supports the blades 16 as they rotate. Rotation of the blade assembly 12 causes rotation of a hub assembly 20 including a generator 21 that converts the kinetic energy of the blades 16 into electrical energy.

The frame 18 includes an upper support subassembly 28 and a lower support subassembly 30. The upper support subassembly 28 includes five top struts 32, each of which extend diagonally upwardly between the top of the generator 21 and a top portion of a corresponding blade 16. A top support spoke 34 extends radially inwardly from each top strut 32. Each top support spoke 34 is coupled to an adjacent top support spoke 34 by a transversely extending upper brace bar 38. Each top support spoke 34 is separated from the nearest adjacent top support spoke by an angular distance of approximately 72° degrees.

The lower support subassembly 30 includes five bottom struts 40, each of which extends diagonally downwardly between the bottom of the generator 21 and a bottom portion of a corresponding one of the blades 16. Each bottom strut 40 is coupled to an adjacent bottom strut 40 by a transversely extending bottom brace bar 42. A bottom support spoke 44 extends radially inwardly from each bottom brace bar 42 Like the top support spokes 34, the bottom support spokes 44, are spaced approximately 72° degrees from one another.

The elements of the upper and lower support subassemblies 28, 30, including top struts 32, top support spokes 34, central support pole 36, upper brace bars 38, bottom struts 40, bottom brace bars 42, and bottom support spokes 44 are preferably tubular elements that have been filled with high strength industrial foam. The foam provides the elements with additional tensile strength and also dampens vibrations, thereby reducing noise.

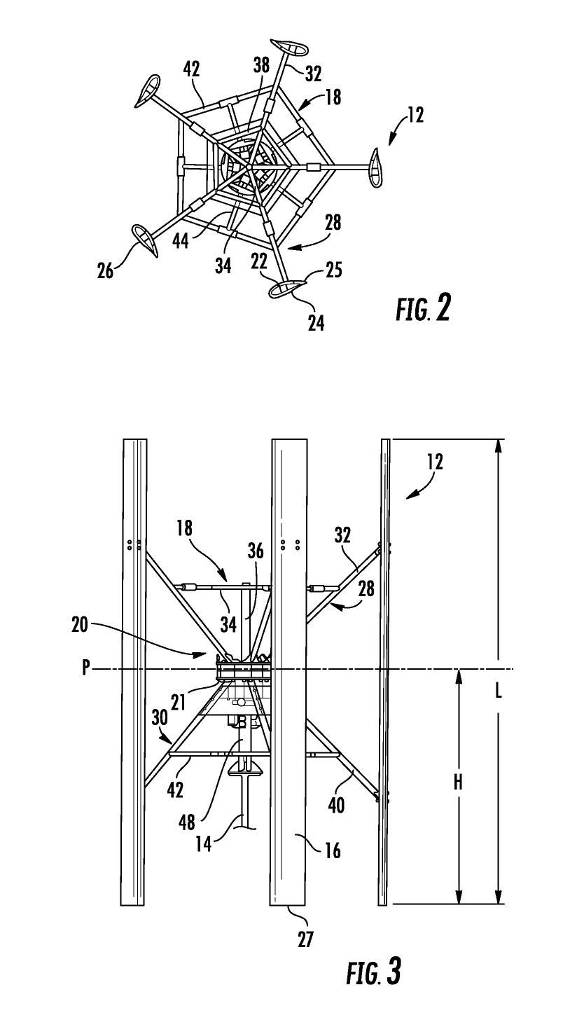

Each blade 16 is designed for maximum aerodynamic efficiency, and has an airfoil-shaped cross section, with a convex, inwardly facing pressure side 22 and an outwardly facing suction side 24 that is generally concave near its trailing edge 25, as shown in FIG. 2. Each end of each blade 16 is covered by a winglet 26 having substantially the same airfoil shape as, but a larger surface area than, the cross-section of the blade 16. These winglets 26 reduce turbulence created by vortices around the ends of the blades, thus reducing lift-induced drag and increasing the overall efficiency of the wind turbine 10.

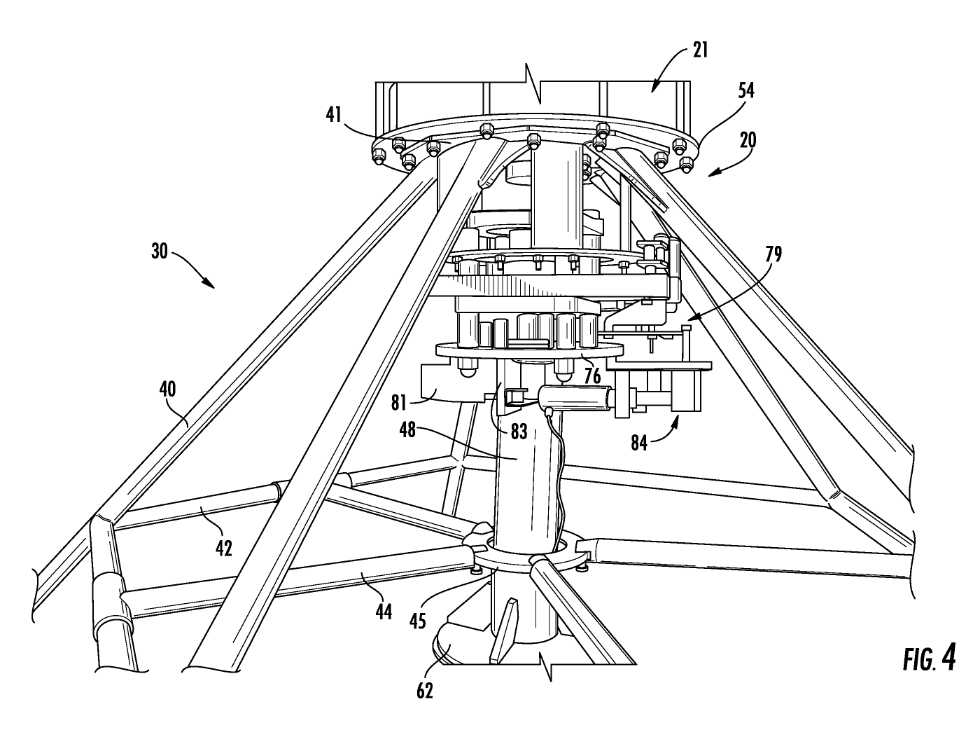

As seen in FIG. 3, the center of the generator 21 is located along a plane P that defines a plane of symmetry for each of the blades 16, as well as for the frame 18. In other words, the height H of the generator above the bottom edge 27 of each blade 16 is equal to half of the length L of the blades 16. Stated differently, the generator 21 is located in the geometric center, which is also approximately the center of mass, of the blade assembly 12. The lower portion of the generator 21 is coupled to a stationary blade support shaft 48 mounted on the vertical pole 14, and the upper portion of the generator 21 is coupled to a central support pole 36 joined to the inner end of each top support spoke 34. The central support pole 36 is approximately the same height as the blade support shaft 48, thus maintaining the overall symmetry and balance of the hub assembly 20.

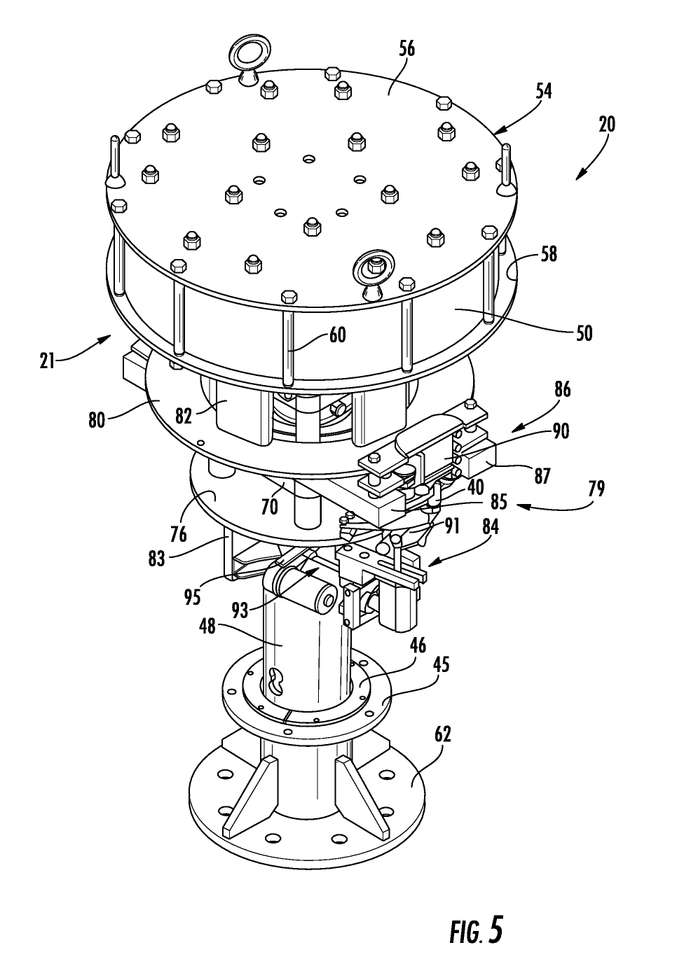

FIG. 4 shows the lower support subassembly 30 and its relationship to the hub assembly 20, which includes the generator 21, the blade support shaft 48, and a disc brake assembly 79. The upper end of each bottom strut 40 is secured to a mounting plate 41 bolted to the bottom of the housing 54 of the generator 21. The inner end of each bottom support spoke 44 is coupled to a support ring 45 that is mounted for rotation about the blade support shaft 48. A radially extending, circular mounting plate 62 at the lower end of the blade support shaft 48 is configured to connect the blade support shaft 48 to the tower. A set of radially extending platform support flanges 81, 83 at the upper end of the blade support shaft 48 carry a circular platform 76 that supports an actuation assembly 84 associated with the disc brake assembly 79.

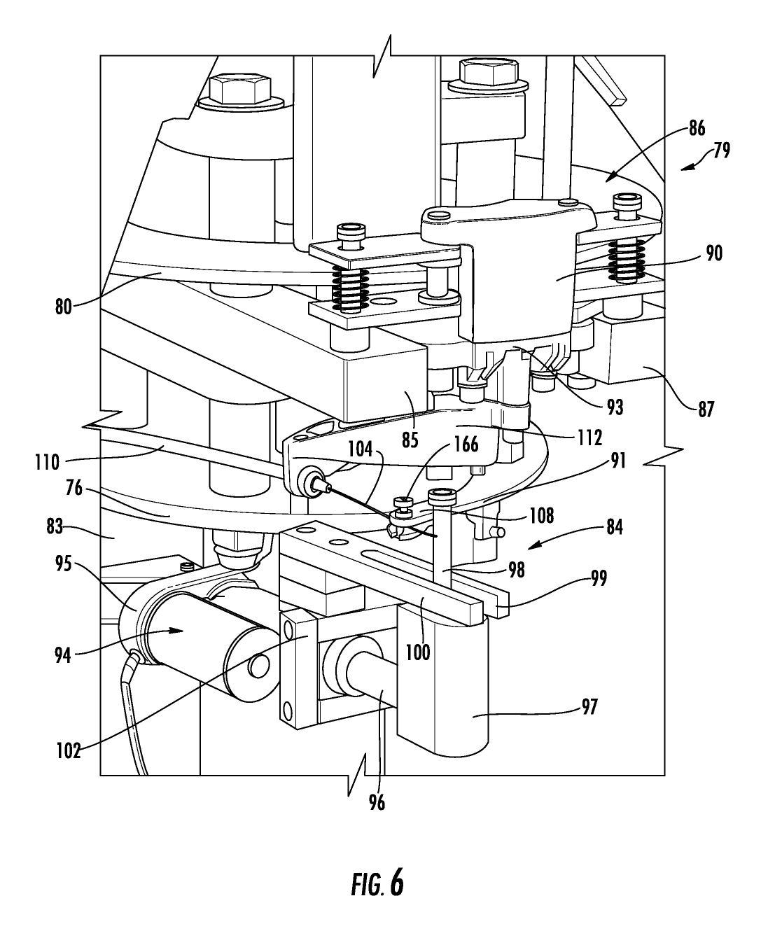

FIG. 5 shows the hub assembly 20 in greater detail. The generator 21 includes a generator rotor 50 protected by the housing 54, which includes a top support plate 56 and bottom support plate 58 that are coupled to one another by rods 60 that extend vertically through the plates 56, 58. The disc brake assembly 79 includes an annular disc 80 that is suspended below the bottom support plate 58 of the housing 54 by vertical bars 82. The disc 80 is interposed between two brake shoes in a piston and caliper assembly 86 that is supported by a pair of spaced apart platform bars 85, 87 extending horizontally beneath the disc 80. In most embodiments, the disc brake assembly 79 will include two piston and caliper assemblies 86 positioned on opposite sides of the disc 80. But in low-wind environments where the expected maximum rpm of the wind turbine is relatively low, a single piston and caliper assembly may be used.

The piston and caliper assembly 86 may include a commercially available caliper 90 such as, for instance, a mechanical parking brake caliper of the type manufactured and sold as caliper number 120-12070 by Wilwood Engineering, Inc. Another suitable type of disc brake caliper is shown and described in U.S. Pat. No. 6,422,354 B1 to Shaw et al. As the practitioner of ordinary skill is aware, these types of calipers include pistons that are acted upon by thrust pins or the like coupled to a lever 91 pivotably coupled to a brake base 93. When pivoted, the lever 91 drives the thrust pins and pistons towards the brake shoes, which in turn are compressed against opposite sides of the disc 80, causing the disc 80 and therefore the entire hub assembly 20, to slow or stop rotating.

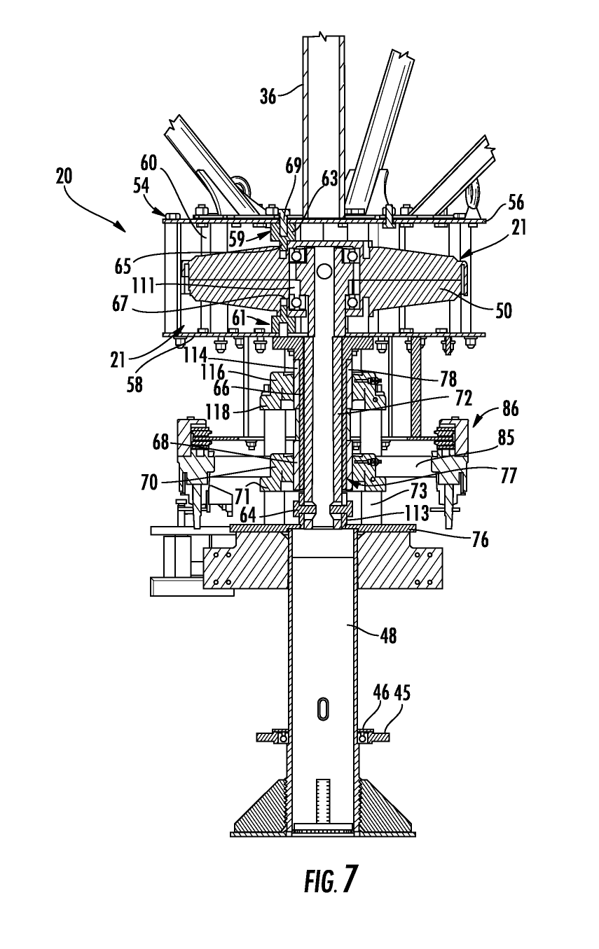

As best seen in FIG. 6, the lever 91 is pivoted by an actuating mechanism 84 including a motorized linear actuator 94 having an actuator base portion 95 secured to one of the platform support flanges 83 extending from the blade support shaft 48. The linear actuator 94 includes a retractable arm 96 that moves in a direction parallel to the plane of the disc 76. An elongated pedestal 97 at the distal end of the arm 96 carries a driving rod 98 that extends perpendicularly to the arm 96, and pushes against the lever 91 when the arm 96 is retracted. The driving rod 98 is carried within a channel 99 formed in a guiding arm 100 carried on a generally U-shaped support bracket 102 that encircles the retractable arm 76 and is coupled to a second one of the platform support flanges. The channel 99 and guiding arm 100 prevent or limit axial movement of the driving rod 98, ensuring that it moves in a substantially axial direction (ie. parallel to the longitudinal axis of the retractable arm 76) towards the lever 91.

A backup actuator is provided for pivoting the lever 91 when the motorized linear actuator 94 is inoperative, for instance during electrical power outages. The backup actuator comprises an elongated cable 104 having a first end secured to a pin 106 or other fastener at the free end 108 of the lever 91 and a second end accessible to an operator on the ground. The cable 104 is preferably encased within a protective sheath 110 and is held in place by a cable support arm 112 coupled to the brake base 93.

Operation of the braking assembly 79 is as follows. When a control unit connected to an anemometer and/or tachometer detects that either the wind speed or the rpm of the turbine has reached a maximum safe value, the motorized linear actuator 94 is energized, causing the retractable arm 96 and the elongated pedestal 97 to move inwardly toward the blade support shaft, until the driving rod 98 contacts the lever 91. This causes the lever 91 to pivot inwardly, which in turn causes the thrust pins and pistons inside the caliper 90 to drive the brake shoes toward one another, clamping them against the disc 32. The frictional engagement between the brake shoes and the disc 76 slows and eventually stops rotation of the disc 76 and the blade support assembly.

Alternatively, if a power outage or other malfunction should prevent the motorized linear actuator 94 from drawing the retractable arm 96 against the lever 91, an operator may manually pivot the lever 91 by pulling the cable 110.

The internal structure of the hub assembly 20 is shown in FIG. 7. The generator rotor 50 is mounted for rotation about a stationary generator shaft 72 and is separated from the upper and lower support plates 56, 58 of the generator housing 54 by an isolator assembly comprising a set of upper isolators 59 and a set of lower isolators 61. Each set of isolators 59, 61 consists of five cylindrical shock-absorbing members spaced at 72° intervals around the generator rotor 50. Each shock-absorbing member has an enlarged base portion 63 and a centrally located, reduced diameter portion 65 that projects into a corresponding recess 67 formed in the generator rotor 50. The base portion 63 of each upper isolator 59 includes a blind bore that receives the shaft of a bolt 69 extending through the top support plate 56, and the base portion of each lower isolator 61 includes a blind bore that receives the shaft of a bolt 71 extending through the bottom support plate 58. The isolators 59, 61, which are preferably made from a resilient material such as rubber, prevent vibrations from the blade assembly 12 from being transmitted to the generator 21, and thus increase the overall stability of the generator 21.

The top end of the generator shaft 72 is received in a cavity 111 in the generator rotor 50. The bottom end of the generator shaft 72 is received in a neck 113 formed in the center of the circular platform 76 on the top of the blade support shaft 48, and is constrained from rotation relative to the blade support shaft 48 by a pair of bolts or pins 64 that extend through aligned holes in the neck 113 and the bottom end of the generator shaft. The intermediate portion of the generator shaft 72 is encased in a protective cylindrical sleeve 66 that extends between the bottom plate 58 of the generator housing 54 and just above the neck 113 of the circular platform 76.

The rotatable components of the vertical axis wind turbine are secured to the blade support shaft 48 by an extremely stable triple-bearing mounting system comprising a first, or lower, bearing 46, a second, or central, bearing 77, and a third, or upper, bearing 78. The lower bearing 46, preferably a rolling element bearing formed from a high strength material such as steel, is interposed between the support ring 45 and the blade support shaft 48 to reduce friction between the support ring 45 and the blade support shaft 48, as well as to safely transfer radial forces and bending moments from the blade assembly to the blade support shaft 48 as the blade assembly rotates about the blade support shaft 48.

The central bearing 77 comprises a bushing 68 that surrounds a lower portion of the cylindrical sleeve 66 around the generator shaft 72 The bushing 68, which may be made from metal or suitable plastics such as phenolics, acetals, Teflon (PTFE), ultra high molecular weight polyethylene (UHMWPE), or nylon, is surrounded by a cylindrical housing 70 having a radially extending bottom flange 71 carried by a set of columns 73 supported by the circular platform 76. The upper surface of the bottom flange 71 supports the platform bars 85 connected to the piston and caliper assemblies 86. Thus, the central bearing 77 performs several important functions: it bears the weight of piston and caliper assemblies 86; it limits lateral movement or wobbling of the lower portion of the generator shaft 72, thereby keeping the generator shaft 72 aligned with the blade support shaft 48; and it ensures that forces exerted by the wind on the turbine blades are transferred to the blade support shaft 48 rather than to the generator rotor 50 or generator shaft 72. In addition, the bushing 68 minimizes frictional forces between the cylindrical sleeve 66 and the central bearing housing 70 as the generator 21 and the sleeve 66 rotate about the generator shaft 72, while still allowing a reasonable amount of axial movement.

The upper bearing 78, like the central bearing 77, comprises a metal or plastic bushing 114 surrounded by a cylindrical housing 116 having a radially extending bottom flange 118 carried by the columns 73. The function of the upper bearing 78 is to support the weight of the generator 21, while limiting lateral movement or wobbling of the upper portion of the generator shaft 72 and transferring any bending moments or other forces to the blade support shaft 48 rather than to the generator rotor 50 or generator shaft 72. The bushing 114 minimizes frictional forces between the cylindrical sleeve 66 and the upper bearing housing 116, while still allowing a reasonable amount of axial movement.

While exemplary embodiments are described above, it is not intended that these embodiments describe all possible forms of the invention. Rather, the words used in the specification are words of description rather than limitation, and it is understood that various changes may be made without departing from the spirit and scope of the invention. For instance, the number of blades in the blade assembly may be changed, along with corresponding changes in the number of struts, support spokes and brace bars for supporting the blades. Additionally, the features of various implementing embodiments may be combined to form further embodiments of the invention.

What is claimed is:

1. A wind turbine comprising:
a blade assembly configured to rotate about a vertical axis, the blade assembly having a center of mass; and
a generator;
wherein the generator is located approximately at the center of mass of the blade assembly.

2. The wind turbine according to claim 1, further comprising a vertically extending blade support shaft, a first bearing, a second bearing, and a third bearing, and wherein:
the generator includes
a vertically extending generator shaft,
a generator rotor mounted for rotation about the generator shaft, and
a generator housing mounted for rotation with the generator rotor; and
the first bearing supports the blade assembly for rotation about the blade support shaft;
the second bearing limits lateral movement of the generator shaft; and
the third bearing supports the weight of the generator rotor and generator housing.

3. The wind turbine according to claim 2, wherein:
the blade assembly comprises a plurality of vertically extending blades, wherein each blade is symmetrical about a common horizontal plane of symmetry; and
the generator is located in the horizontal plane of symmetry.

4. The wind turbine according to claim 3, wherein the blade assembly includes
an upper support subassembly including a plurality of top struts extending diagonally upwardly between an upper portion of the generator housing and the blades, and
a lower support subassembly including a plurality of bottom struts extending diagonally downwardly between a bottom portion of the generator housing and the blades.

5. The wind turbine according to claim 4, wherein:
the upper support subassembly further includes
a central support pole extending upwardly from the upper portion of the generator housing, and
a plurality of upper support spokes extending horizontally and radially between the central support pole and the top struts; and
the lower support assembly further includes a plurality of lower support spokes extending horizontally and radially between the blade support shaft and the bottom struts.

6. The wind turbine according to claim 1, wherein:
the generator comprises
a generator rotor; and
a generator housing including
a top support plate,
a bottom support plate, and
an isolator assembly configured to space the top and bottom support plates from the generator rotor and to reduce transmission of vibrations from the blade assembly to the generator rotor.

7. The wind turbine according to claim 6, wherein:
the isolator assembly comprises
a set of upper isolators separating the top support plate from a top surface of the generator rotor, and
a set of lower isolators separating the bottom support plate from a bottom surface of the generator rotor,
wherein each isolator includes
a cylindrical shock-absorbing member having a bore formed in one end and a projection formed on a second end, the projection extending into a recess formed in a surface of the generator rotor, and
a fastener extending through one of the support plates and into the bore formed in the shock-absorbing member.

8. A wind turbine comprising:
a vertically extending blade support shaft;
a plurality of vertically extending blades;
a first bearing supporting the blades for rotation about the blade support shaft;
a generator including
a generator shaft coupled to and constrained against rotation relative to the blade support shaft,
a generator rotor mounted for rotation about the generator shaft; and
a generator housing mounted for rotation with the generator rotor;
a second bearing limiting lateral movement of the generator shaft; and
a third bearing the weight of the generator rotor and generator housing.

9. The wind turbine according to claim 8, further comprising:
an upper support subassembly including a plurality of top struts extending diagonally upwardly between the generator housing and the blades, and
a lower support subassembly including a plurality of bottom struts extending diagonally downwardly between the generator housing and the blades.

10. The wind turbine according to claim 9, wherein:
the upper support subassembly further includes
a central support pole extending upwardly from generator housing,
a plurality of radially extending upper support spokes, each upper spoke having a first end secured to a top end of the central support pole and a second end secured to a top strut, and
a plurality of upper brace bars, each upper brace bar extending transversely between adjacent upper support spokes; and
the lower support subassembly further includes
a plurality of lower brace bars, each lower brace bar extending transversely between adjacent bottom struts, and
a plurality of radially extending lower spokes, each lower spoke having a first end secured to the first bearing and a second end secured to a lower brace bar.

11. The wind turbine according to claim 10, wherein:
each blade is symmetrical about a common horizontal plane of symmetry; and
the generator is located in the common horizontal plane of symmetry.

12. The wind turbine according to claim 8, further comprising:
a disc coupled to and suspended beneath the generator housing; and
a piston and caliper assembly cooperating with the disc to function as a brake stopping or slowing rotation of the blades.

13. The wind turbine according to claim 12, wherein:
the disc is integrally coupled to the generator housing by at least one bar extending downwardly from the generator housing; and
an actuator for a piston and caliper assembly is secured to a platform extending radially outwardly from the blade support shaft.

14. The wind turbine according to claim 12, wherein:
the second bearing is located between the platform and the disc; and
the third bearing is between the second bearing and the generator.

15. A wind turbine comprising:
a plurality of vertically extending blades, wherein each blade is symmetrical about a common horizontal plane of symmetry; and
a generator located in the horizontal plane of symmetry of the blades, the generator including a generator housing and a generator shaft;
wherein the blades and the generator housing are supported for rotation about a common vertical axis.

16. The wind turbine according to claim 15, further comprising a frame configured to secure the blades to the generator housing, the frame including:
an upper support subassembly including a plurality of top struts extending diagonally upwardly between the generator housing and the blades; and
a lower support subassembly including a plurality of bottom struts extending diagonally downwardly between the generator housing and the blades.

17. The wind turbine according to claim 16, further comprising:
a first bearing secured to the lower support subassembly and supporting the frame for rotation about a vertically extending blade support shaft;
a second bearing maintaining the generator shaft in axial alignment with the blade support shaft; and
a third bearing supporting the weight of the generator housing.

18. The wind turbine according to claim 17, wherein:
the upper support subassembly further includes
a central support pole extending upwardly from the generator housing,
a plurality of radially extending upper support spokes, each upper support spoke having a first end secured to a top end of the central support pole and a second end secured to a top strut, and
a plurality of upper brace bars, each upper brace bar extending transversely between adjacent upper support spokes; and
the lower support subassembly further includes
a plurality of lower brace bars, each lower brace bar extending transversely between adjacent bottom struts, and
a plurality of radially extending lower support spokes, each lower spoke having a first end secured to the first bearing and a second end secured to a lower brace bar.

19. The wind turbine according to claim 18, wherein the central support pole is coaxial with the generator shaft and the blade support shaft.

20. The wind turbine according to claim 15, further comprising:
a disc suspended beneath and parallel to the generator housing; and
a piston and caliper assembly cooperating with the disc to function as a brake stopping or slowing rotation of the blades.
